(19) United States
(12) Patent Application Publication
(10) Pub. No.: US 2013/0202374 A1
(43) Pub. Date: Aug. 8, 2013

(54) SIMPLIFIED JIG BORING HEAD

(71) Applicant: David Tom, San Francisco, CA (US)

(72) Inventor: David Tom, San Francisco, CA (US)

(21) Appl. No.: 13/367,311

(22) Filed: Feb. 6, 2012

(51) Int. Cl. B23B 29/034; B23B 43/00

(52) U.S. Cl. 408/147

(57) ABSTRACT

A jig boring head, having a holder for holding a cutting bit, mounted to a spindle on a jig boring machine in a two-piece collar on the spindle, with the tool bit holder securely connected to the collar and slidably adjustable in a direction radial to the spindle, so that a simple, easily implemented method for radial cutting with a jig boring machine is realized.

### PRIOR ART

The prior art below relates primarily to jig boring tools, as they are commonly known in the machining art.

The term “jig”, when used in tooling, has many meanings, ranging from a simple plate used as a template, such as for hole locations, to very large, complex machines primarily used for boring holes in often very large pieces of material. However, the term “jig boring” often means complex machinery for extremely accurate hole drilling and/or finishing, such as smoothing, or precise hole sizing. Such uses normally require both “in line” boring, such as precision drilling in a material, and “facing” operations, often known by other names, such as “radial” boring, which involves smoothing or adjusting cuts with a tool bit inserted within a material.

As defined in the free internet dictionary, Wikipedia, on Aug. 27, 2010:

“The jig borer is a type of machine tool invented at the end of World War Ito make possible the quick-yet-very-precise location of hole centers. It was invented independently in the United States and Switzerland. It can be viewed as a specialized species of boring mill or milling machine that provided tool and die makers with a higher degree of positioning precision (repeatability) and accuracy than those general machines had previously provided.”

In jig boring, a boring bit for precisely cutting material, such as metal, is disposed with a radial holder for cutting inside a hole, such as a large hole which is not amenable to drilling operations.

It is often desired that very small adjustments be made to a tooling bit position, such that very fine increases in the cut depth in a material may be made. This is often desired for many reasons, with three given below:

1. for providing a smooth surface, such as with a very fine smoothing cut,
2. for using high speed steel instead of more expensive cutters, such as carbide bits, to decrease the cost. The use of high speed steel requires that the cut depth be carefully controlled, as otherwise the bit may be damaged by the resulting pressure from a deeper cut which may be exerted on the bit.
3. Making very small cuts, such as to finish a part which is found to require a small amount of extra cutting, similar to a smoothing cut, but for a different reason; to adjust the size of the cut.

Wikipedia further tells us:

“Before the jig borer was developed, hole center location had been accomplished either with layout (either quickly-but-imprecisely or painstakingly-and-precisely) or with drill jigs (themselves made with painstaking-and-precise layout). The jig borer was invented to expedite the making of drill jigs, but it helped to eliminate the need for drill jigs entirely by making quick precision directly available for the parts that the jigs would have been created for. The revolutionary underlying principle was that advances in machine tool control that expedited the making of jigs were fundamentally a way to expedite the cutting process itself, for which the jig was just a means to an end. Thus the jig borer's development helped advance machine tool technology toward later NC and CNC development. The jig borer was a logical extension of manual machine tool technology that began to incorporate some then-novel concepts that would become routine with NC and CNC control, such as:
coordinate dimensioning (dimensioning of all locations on the part from a single reference point);
working routinely in “tenths” (ten-thousandths of an inch, 0.0001″) as a fast, everyday machine capability (whereas it formerly was the exclusive domain of special, time-consuming, craftsman-dependent manual skills); and
circumventing jigs altogether.

Franklin D. Jones, in his textbook Machine Shop Training Course (5th ed), recorded insightfully:

“In many cases, a jig borer is a ‘jig eliminator.’ In other words, such a machine may be used instead of a jig either when the quantity of work is not large enough to warrant making a jig or when there is insufficient time for jig making.””

Further research shows the following regarding jig boring:

“The lateral movement of the boring head and the movement of the table are controlled by lead-screws, set by micrometer drums. A pitch-correction device rotates the vernier sector, by which the setting of the micrometer drum is made, by an amount which eliminates the error at the position in which the table or head is being set. The amount of rotation is determined by a lever, in the ratio of 200:1, in contact with a metal template. The template was made for each lead-screw in terms of a high precision scale read with a microscope at one centimetre intervals.”

Often the complicated and expensive arrangement described above is not required. An operator may need to measure a dimension, then adjust the bit by a very small amount, but without the need or desire for a micrometer adjustment such as with a vernier instrument. This is especially true of less developed or developing nations, where the technology does not exist to develop state of the art machines, and the financial ability to buy such machines cannot be found.

U.S. Pat. No. 8,092,124 teaches a facing mill head with screw-adjustable holders in keyed slots. The slots are in a mill head shaped much like a collar; in that it radially extends beyond an abutting boring bar. The '124 patent includes a locking screw, something like a set screw. The locking screw of the '124 patent forms a firm connection to the above head by distorting the holder, which has slots axial to the holder provided to allow such distortion. While the '124 patent discloses many desirable and long-needed features, distorting the holder, and the need for a through screw for such distortion, precludes many bits, such as “bar” bits of a hard material, while such distortion may cause bit misalignment. Further, the '124 patent, which uses a conical head screw for adjustment, allows a very narrow range of adjustment of the holder, much less than is often desired, and changing a bit requires dismounting the holder because removing the screw removes the holder. Further, the '124 patent teaches a dead-end head for holder mounting, and cannot be positioned at an arbitrary point along a boring bar. The '124 patent also teaches a holder and slot for said holder that require special care in machining and general preparation; a simpler, less expensive bit holder and device for positioning the holder is needed. Even so, the '124 patent is a significant improvement over the art before it. More needs to be done, though, since it is often desirable to, for example, position a bit along, for example, a boring bar (less important with a milling head, as in the '124 patent), or to improve the range of adjustment (less important with a milling head). Cost and simplicity, such as for maintenance, is also of great importance, especially when, as with a boring tool, a bit is not always visible, but may be positioned within a part being machined.

U.S. Pat. No. 2,654,610 teaches a jig boring head for adjusting a bit position relative to a material being machined in a jig boring machine. The '610 patent includes a vernier adjustment for making small increments in a position of a bit or similar cutting tool, but does not anticipate using a simpler, less costly, and often sturdier, therefore longer lasting, apparatus for the same purpose.

U.S. Pat. No. 3,067,636 teaches a jig boring head for cutting tool positioning in a jig boring machine, and similarly does not anticipate the use of a low-cost, simple, and sturdy apparatus for the same purpose.

U.S. Pat. No. 3,069,932 teaches an apparatus for using a head for a cutting tool in a jig boring machine by radial changes of an orientation of said tool with an offset lead screw. While the '932 patent shows achieving a fine adjustment with a lead screw, and is therefore simpler than using vernier adjustment, the adjustment apparatus of the '932 patent is non-linear and causes a change in the relative positioning of the cutting tool with respect to the material being cut. These factors are only a few of the disadvantages of the '932 patent, which teaches a machine that is somewhat complex and costly to implement.

U.S. Pat. No. 3,144,792 teaches fine adjustment of a cutting tool in a jig boring head or similar apparatus, by means of a relatively coarse adjustment, such as with a lead screw, as is known in the art, and a finer adjustment by means of a vernier apparatus. With two interacting adjustment means, the teaching of the '792 patent is more complex and more costly than the present invention.

U.S. Pat. No. 3,144,792 teaches fine adjustment of a cutting tool in a jig boring apparatus with a micrometer adjustment, and including an anti-backlash improvement for boring eccentric to a turning axis. The '792 patent, while providing for less distortion, such as with vibration or other disturbance, is more complex and more costly than the present invention.

U.S. Pat. No. 3,647,307 relates only to a boring bar, and while it does hold a tool bit for cutting, such as in jig boring, is not directly relevant to the jig boring apparatus of the present invention.

There is a long felt, unsatisfied need for a simple, low cost, sturdy jig boring apparatus or head for making incremental adjustments to tools used for cutting and shaping materials, such as jig borers. There is also a long felt unmet need for a jig boring head that is adapted solely for radial boring to eliminate the need for costly and complex mechanisms for performing this function.

### SUMMARY OF THE INVENTION

Tooling, such as jig boring tools, in the United States are generally complex, since they are usually intended to minimize physical labor, with relatively little thought to the cost of the tooling. In other countries, such as P. R. China, the opposite may be true. Labor may be low in cost, and the cost of tooling, especially high wear, relatively short life time tooling such as jig boring tools, may be much more of a concern.

As a result, there is a great need for very simple, low cost tooling, yet the thinking resulting in such simple tooling may be as complex or even more complex than for more complex tooling, since the simplest solution is often the least obvious. As Einstein once said, “An intelligent man can solve even the most complex problem; a genius makes the problem simple”.

However, it is well understood in many parts of the world, or even generally, that one does not pay for something one is not legally obligated to pay for. Therefore, an inventor who teaches a simple, yet powerful tooling approach, if the approach is unique, must obtain legal protection, or there will be little or no incentive for developing such tooling.

In the case of tooling used for products to be used in the United States of America, this means a US patent for such an invention; since legal protection for an invention may be non-existent outside the US. This presents a problem for an inventor: technology that might be considered trivial (even though recognized as very inventive) in the US, is still of great value for an inventor serving the needs of American companies overseas, for example, in P. R. China.

Fortunately the US Patent Law recognizes the value of simplicity in an invention, so such protection may be available. Without it, both American and overseas companies would suffer.

The invention described herein is simple, and therefore low in cost, but extremely inventive, as will be shown in the following disclosure.

A collar of a rigid material, such as steel, is placed around a spindle on a jig boring machine, as these terms are known in the art, and securely fastened in place. A tool holder, rigidly constrained by keying slots in all directions, except for motion radially outward or inward with respect to said spindle. is integral to said collar, and a tool bit is inserted and secured in said tool holder. Said tool holder and interface within said collar secures a screw for advancing and/or retarding said tool holder, and thereby said bit, with respect to said collar and said spindle to which said collar is secured. It is important to understand that said collar, unlike most tooling solutions, may be positioned at an arbitrary point along a spindle of a machine, rather than only at an end of said spindle, since said collar may be mounted on a machine with limited ability for positioning said spindle with respect to a work piece.

Said collar, including said tool holder, are of a rugged construction, which serves to minimize deflections and vibrations of said bit with respect to said spindle to allow precision work to be done.

Said collar being of a substantial construction, provides an inertial moment, similar to a gyroscopic action, for further reducing vibrations and deflections due to forces created by tooling cuts.

Said tool holder captures a bit, in a preferred embodiment, by encircling said bit, though other means of securing said bit are anticipated hereby, and includes means for securely holding said bit in place, such as with set screws. Said bit is easily exchanged when desired, while said tool holder holds said bit securely in place during operations such as in jig boring.

It will be appreciated that the simplified jig boring head of this invention is configured for radial boring, and provides a jig boring head with maximal ruggedness and long life, as well as relative freedom from vibration or similar error-producing aberrations, all with minimal expense and minimal complexity in making said jig boring head.

### BRIEF DESCRIPTION OF THE EMBODIMENTS OF THE INVENTION

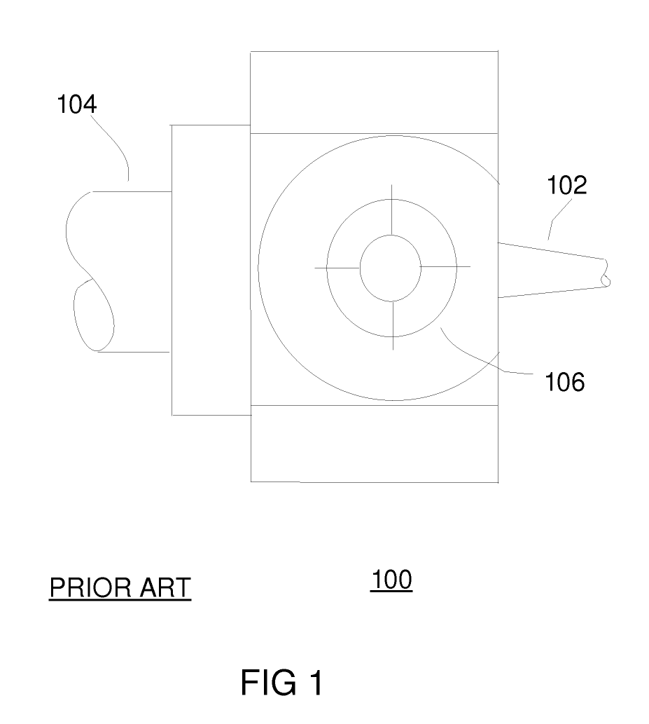

FIG. 1 is a jig boring head of the prior art, comprising an apparatus for securing a tool holder and/or tool bit to a spindle on a jig boring machine, and is relatively complex and expensive to make.

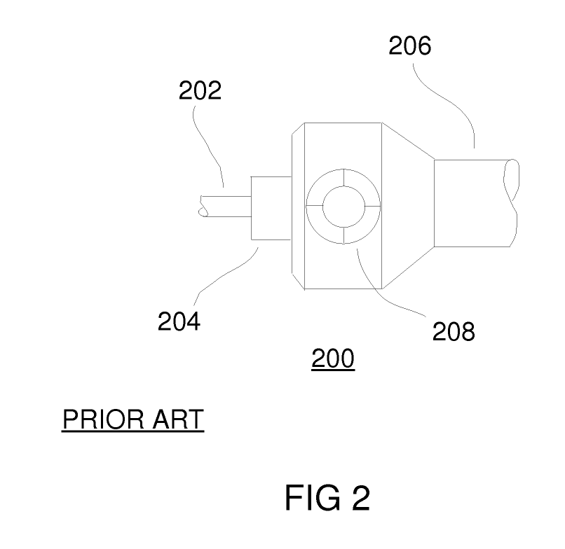

FIG. 2 is another jig boring head of the prior art, further comprising an apparatus for securing a tool holder to a spindle on a jig boring machine, and is relatively complex and expensive to make.

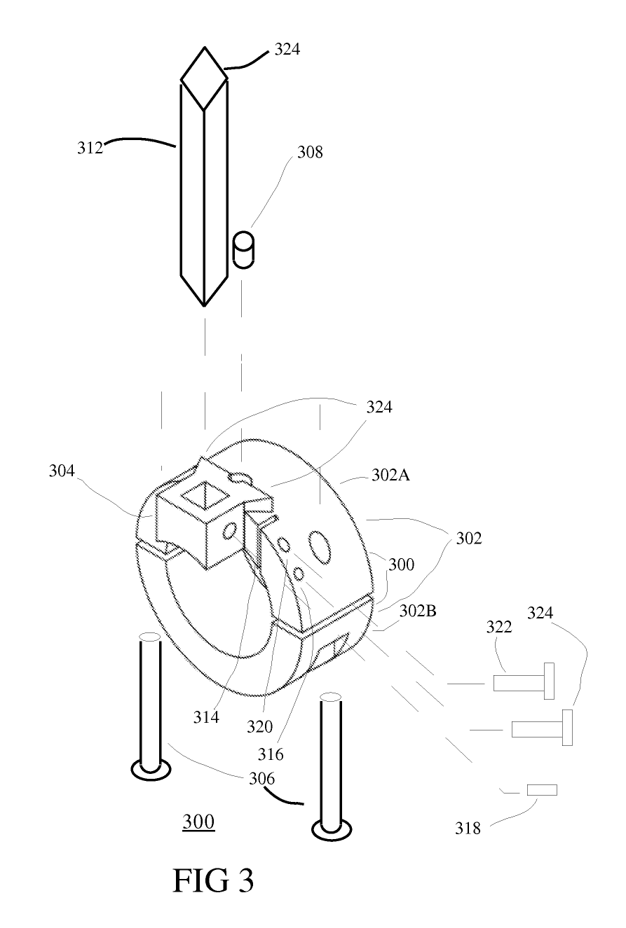

FIG. 3 is an exploded view of a preferred embodiment of this invention, disclosing a bit to be secured fixedly in a tool holder of this invention, said tool holder for being secured slidably on a collar of this invention, said collar for being secured to a tool spindle on a machine (not shown).

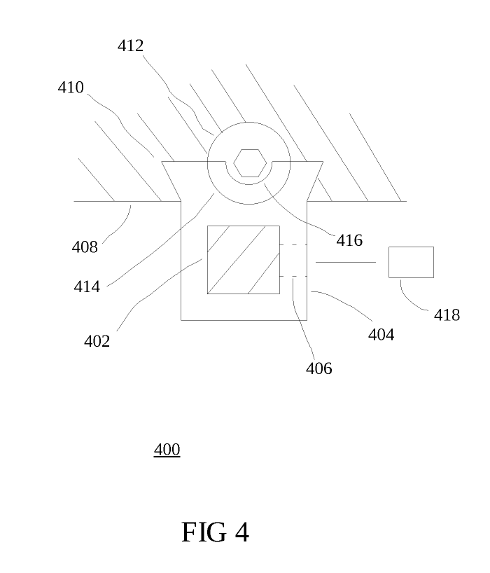

FIG. 4 is a partial embodiment of this invention, showing a top view of the tool holder of this invention, and illustrating how said tool holder is held firmly by a collar of this invention by means of keyed flanges on said tool holder, said tool holder being slidably radially adjustable with respect to a spindle of a machine, while said collar is slidably adjustable along said spindle.

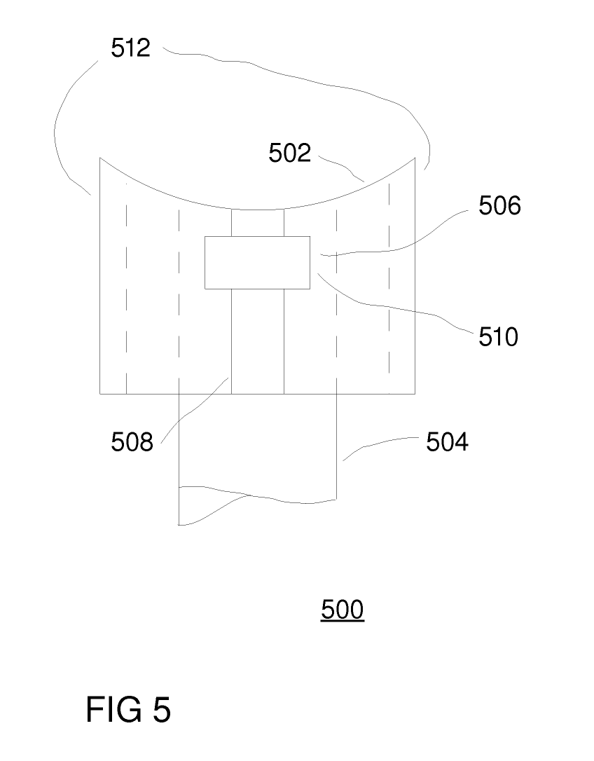

FIG. 5 is a partial embodiment of the invention showing a face of a tool holder of this invention which more clearly discloses how an adjusting screw of this invention is held by said tool holder to slidably adjust a position of a tooling bit with respect to a spindle on a jig boring machine.

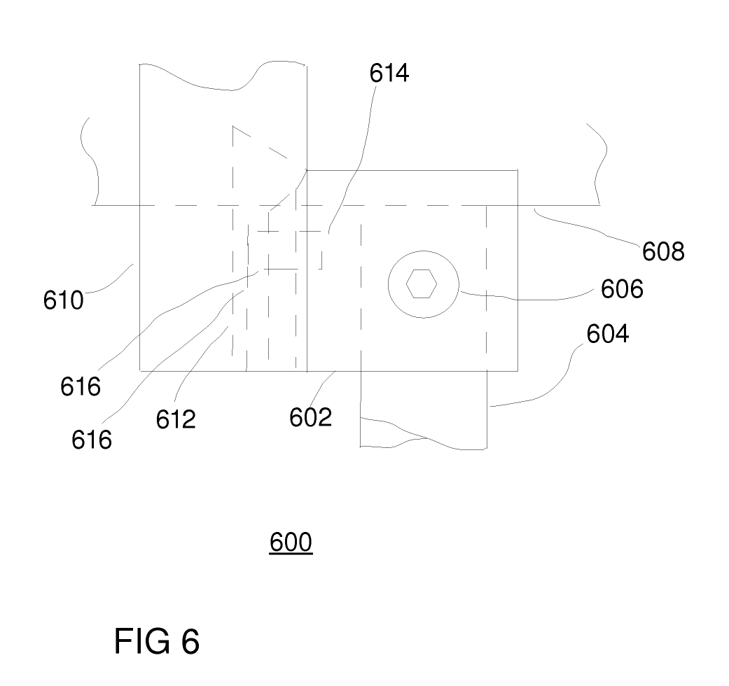

FIG. 6 is a partial embodiment of the invention more clearly disclosing how a tool holder of this invention is held by a collar of this invention with respect to a spindle of a jig boring machine.

### DETAILED DESCRIPTION OF THE EMBODIMENTS OF THE INVENTION

FIG. 1 is an embodiment of the prior art disclosing a jig boring head 100, comprising securing a tool holder which is integral to said head 100, and a tool bit 102 (partial view), to a spindle 104 on a jig boring machine (not shown). Head 100 incorporates a vernier dial 106 for adjustment of a position of a bit 102 with respect to said head 100. Within head 100 said dial 106 controls gears, screws, and other complex mechanisms (not shown) to provide for fine control of said bit 102.

FIG. 2 is another embodiment of the prior art disclosing a jig boring head 200, further comprising an apparatus for securing a tool holder 202 with a tooling bit 204 (partial view) to a spindle 206 on a jig boring machine. Head 200 has a vernier dial 208 for adjusting said bit 204 extension length from said head 200. Within said head 200 said dial 206 controls gears, screws, and other complex mechanisms (not shown) to provide for fine control of said bit 202.

FIG. 3 is an exploded view of a preferred embodiment 300 of this invention, in which a tool holder 304 of this invention is partially inserted into a collar 302, and illustrates how said holder 304 is held firmly in all directions, except radially, to a spindle (not shown) through said collar 302, by means of keyed flanges 310 on said holder 304 engaging said collar piece 302A, with said holder 304 being slidably adjustable across said collar 302 in a direction radial to a center of said collar 302. In this embodiment 300, collar 302, which is comprised of two pieces, collar piece 302A and collar piece 302B, is secured around said spindle (not shown) by screws 306, which are threaded into said collar piece 302A through openings in collar piece 302B. Bit holder 304 is adjusted by headless screw 308. Screw 308 threadedly engages collar 302, specifically collar piece 302A, and slidably engages said holder 304 within a recess, 506 in FIG. 5, in said holder 304, whereby a rotation of said screw 308 slidably adjusts a position of holder 304 with respect to said collar 302, and specifically with respect to collar piece 302A. Flanges 310 on said holder 304 further secure said holder 304 to collar piece 302A. Collar 302, being of a substantial construction, provides an inertial moment thereby damping vibrations or similar aberrations of a bit 312 by a gyroscopic action upon a rotation of said collar 302. Said bit 312 is held firmly in said holder 304 by a set screw 318. Tab or gib screw 322 inserted threadedly through opening 320 and tab or gib screw 324 inserted threadedly through opening 316, further secure said holder 304 by a flexure of a tab 314 toward said holder 304.

FIG. 4 is another embodiment 400 of this invention, disclosing a cutting bit 402 secured fixedly in a tool holder 404 by at least one set screw 418 of this invention. A threaded opening 406 of tool holder 404 engages screw 418 to secure bit 402. Said tool holder 404 is secured slidably on a collar 408 of this invention. Said collar 408 is secured to a spindle (not shown) on a machine, such as a jig boring machine (not shown). Said holder 404 is keyed to said collar 408 by tabs 410, thereby constraining any motion of said holder 404 other than parallel to a long axis of said tabs 410. Holder 404 is made adjustable by headless screw 416, which engages threads 412 on collar 408, and engages holder 404 in a recess 414 provided for that purpose. Screw 416 is held against collar 408 by holder 404 to ensure said threadable engagement of said threads 412 with screw 416 in collar 408. Screw 416 is constrained by holder 404 without threading, whereby holder 404 is free to move with screw 416 and thereby with respect to collar 408 as screw 416 is rotated through an opening 420 to recess 414 provided for that purpose.

FIG. 5 is an embodiment 500 of this invention showing a face of a tool holder 502 securing a tool bit 504. Recess 506 in tool holder 502 engages an adjusting screw 510. Tabs 512 provide keying to a collar (not shown) for slidingly securing said holder 502 in a direction orthogonal to a long axis of said tabs 512. Tool holder 502 is shaped appropriately to engage a spindle contained within said collar (not shown), said collar (not shown) engaging holder 502, thereby providing maximal contact with said collar (not shown) and tabs 512.

FIG. 6 is an embodiment 600 of this invention more clearly disclosing how a tool holder 602 is held within a collar 610 by engagement with keying tabs 612. Collar 610 is shown mounted on a spindle 608 of a jig boring machine (not shown). Tool holder 602 secures bit 604 with set screw 606. Recess 614 holds an adjusting screw 616 for adjusting holder 602 with respect to collar 610 and thereby spindle 608. Said adjusting screw 616 engages collar 610 through groove 616 in collar 610, which also allows access for adjusting said adjusting screw 616.

I claim:

1. In the tooling art; and particularly in the art of metal cutting, shaping, and grinding; wherein a tool bit holder is incorporated as a cutting, shaping, or grinding medium, and more particularly with a type of cutting, shaping, and grinding tool called a jig boring tool having a tool bit holder for holding a cutting bit, said head being mounted on a spindle of a machine for such operations, wherein the invention comprises: mounting a two piece collar on said spindle, with a tool bit holder securely connected to said collar, said tool bit holder being slidably adjustable in a direction radial to said spindle, whereby a simple, inexpensive method for radial cutting in a jig boring machine is realized.

2. A jig boring head of claim 1, further comprising a deformable tab or gib on said collar, with tab or gib screws to provide additional tensioning to said tab or gib, whereby said tool bit holder is securely held in all directions with respect to said collar after tightening said gib screws.

3. A jig boring head of claim 1, further comprising a screw adjustment feature to facilitate fine adjustment of a radial position of said tool bit holder with respect to said collar.

4. A jig boring head of claim 1, further comprising said collar in two pieces being secured with screws or other means to facilitate a mounting of said collar on a spindle of a machine.

5. In the tooling art; and particularly in the art of metal cutting, shaping, and grinding; wherein a tool bit holder is incorporated as a cutting, shaping, or grinding medium, and more particularly with a type of cutting, shaping, and grinding tool called a jig boring tool having a tool bit holder for holding a cutting bit, said head being mounted on a spindle of a machine for such operations, wherein the invention comprises: jig boring head, further comprising a tool bit holder for holding a cutting bit, said head being mounted to a spindle on a jig boring machine, wherein the invention comprises: providing a jig boring head in which a tool bit is configured in a tool bit holder for radially outwardly boring, whereby said head comprises a simple, easily implemented means for boring from inside an opening.

6. A jig boring head of claim 5, further comprising a deformable tab or gib on a collar, with tab or gib screws to provide additional tensioning to said tab or gib, whereby said tool bit holder is securely held in all directions with respect to said collar after tightening said gib screws for deforming said tab or gib.

7. A jig boring head of claim 5, further comprising a screw adjustment feature to facilitate adjustment of a radial position of said tool bit holder with respect to said collar.

8. A jig boring head of claim 5, further comprising a collar being in two pieces to be secured with screws or other means to facilitate mounting of said collar on a spindle of a machine.

9. In the tooling art; and particularly in the art of metal cutting, shaping, and grinding; wherein a tool bit holder is incorporated as a cutting, shaping, or grinding medium, and more particularly with a type of cutting, shaping, and grinding tool called a jig boring tool having a tool bit holder for holding a cutting bit, said head being mounted on a spindle of a machine for such operations, wherein the invention comprises: providing a jig boring head assembly in the form of a collar secured around said spindle in which a tool bit is configured for radially outwardly boring, and said collar provides an inertial moment for dampening vibrations and other aberrations, and comprises a less complex and easily implemented means for boring large holes.

10. A jig boring head of claim 9, further comprising a deformable tab or gib on said collar, with tab or gib screws to provide additional tensioning to said tab or gib, whereby said tool bit holder is securely held in all directions with respect to a collar after tightening said tab or gib screws.

11. A jig boring head of claim 9, further comprising a screw adjustment feature to facilitate adjustment of a radial position of a tool bit holder with respect to a collar.

12. A jig boring head of claim 9, further comprising a collar in two pieces to be secured with screws or other means to facilitate mounting of said collar to a spindle on a machine.
